(19) United States
(12) Patent Application Publication
(10) Pub. No.: US 2007/0202260 A1
(43) Pub. Date: Aug. 30, 2007

(54) METHOD OF MANUFACTURING AN INFORMATION RECORDING MEDIUM

(75) Inventors: Kuniyasu ITO, Toyko (JP); Kazuhiro HATTORI, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/677,293

(22) Filed: Feb. 21, 2007

(30) Foreign Application Priority Data
Feb. 27, 2006 (JP) 2006-50577
Jan. 25, 2007 (JP) 2007-14727

(51) Int. Cl. B05D 3/12

(52) U.S. Cl. 427/355

(57) ABSTRACT

A method of manufacturing an information recording medium includes an applied layer forming process that applies a fluid material onto a concave/convex pattern formation surface of a substrate where a concave/convex pattern is formed to form an applied layer and a smoothing process that smoothes the surface of the substrate by rubbing a smoothing member against the applied layer.

### BACKGROUND OF THE INVENTION

1. Field of the Invention

The present invention relates to a method of manufacturing an information recording medium that manufactures an information recording medium using a substrate on which a concave/convex pattern has been formed.

2. Description of the Related Art

As one example of this type of a method of manufacturing an information recording medium, in Japanese Laid-Open Patent Publication No. 2004-295989 the present applicant discloses a method of manufacturing a discrete-type magnetic disk. In a first step of this method of manufacturing, concave parts are formed in a second mask layer of a preform used to manufacture a magnetic disk by imprinting. Next, a first mask layer at the bottom surfaces of the concave parts and an intermediate protective layer therebelow are removed from the preform by etching to form concave parts whose depth reaches a continuous recording layer. After this, by removing the continuous recording layer from the preform at the bottom surfaces of such concave parts by carrying out another etching process, the concave parts are formed with a depth that reaches an oriented layer. By doing so, divided recording elements (i.e., the convex parts in the concave/convex pattern) are formed on the preform.

Next, the concave parts between the convex parts used as the divided recording elements are filled with a non-magnetic material by sputtering. When doing so, the non-magnetic material is sputtered onto the concave/convex pattern with sufficient thickness to completely fill the concave parts with the non-magnetic material. Next, the surface of the layer of non-magnetic material (hereinafter simply the “non-magnetic layer”) is polished by CMP (Chemical Mechanical Polishing). When doing so, by removing non-magnetic material on the convex parts and unnecessary non-magnetic material on the concave parts from the preform together with the first mask layer remaining on the convex parts, the surface of the preform is made smooth. After this, by forming a surface protective layer by CVD and applying a lubricant as necessary, the magnetic disk is completed.

### SUMMARY OF THE INVENTION

However, by investigating the above method of manufacturing a magnetic disk disclosed by the present applicant, the present inventors found the following problem to be solved. In the method of manufacturing disclosed by the applicant, after the non-magnetic layer has been formed so as to cover the convex parts used as the divided recording elements, the surface of the non-magnetic layer is polished by CMP to become smooth. When a polishing process (i.e., a smoothing process) is carried out by CMP, after the polishing has been completed, polishing slurry will remain on the surface of the object that has been polished (hereinafter the “processed object”, in this example, the preform). Therefore, before the surface protective layer can be formed, the polishing slurry has to be removed, such as by washing the surface of the preform (i.e., the surface smoothed by polishing) with purified water. This means that with the method of manufacturing disclosed by the applicant, there is the problem that the throughput falls when manufacturing magnetic disks due to the need to remove (i.e., wash off) the polishing slurry. The present invention addresses and solves this problem.

The present invention was conceived in view of the problem described above and it is a principal object of the present invention to provide a method of manufacturing an information recording medium that can improve throughput during manufacturing.

A method of manufacturing an information recording medium according to the present invention includes: an applied layer forming process that applies a fluid material onto a concave/convex pattern formation surface of a substrate where a concave/convex pattern is formed to form an applied layer; and a smoothing process that smoothes the surface of the substrate by rubbing a smoothing member against the applied layer. Note that the expression “fluid material” in the present specification includes various types of resin material and lubricant that exhibit fluidity.

According to this method of manufacturing an information recording medium, unlike a method of manufacturing that smoothes the surface of a substrate by polishing the surface of a non-magnetic layer using CMP, it is possible to proceed to the following manufacturing process without having to carry out a removing process (washing process) to remove polishing slurry after the smoothing has been completed. Accordingly, it is possible to sufficiently improve the throughput when manufacturing an information recording medium. Here, unlike a method of manufacturing that fills concave parts with a non-magnetic material such as silicon oxide, with the method of manufacturing that forms an applied layer (for example, a resin layer) by applying a fluid material (for example, a resin material), it is possible to reliably and sufficiently smooth the surface of the substrate using an apparatus with a comparatively simple construction, such as a burnishing apparatus.

In this method of manufacturing an information recording medium, a first hardening process, which hardens the applied layer so as to lower the fluidity of the fluid material compared to when the fluid material is applied, may be carried out before the smoothing process, and in the smoothing process, the surface of the applied layer may be polished using a dry polishing member as the smoothing member to smooth the surface of the applied layer. Note that the expression to “polish” in this specification includes to smooth the applied layer by rubbing a polishing member to cause plastic deformation of the applied layer, to grind away (grinding) the applied layer by rubbing a polishing member against the applied layer, and to carry out both plastic deformation and grinding away simultaneously.

According to this method of manufacturing an information recording medium, the surface of the substrate can be smoothed while efficiently removing (i.e., grinding away) the fluid material from the substrate without the fluid material removed (ground away) by the dry polishing member readhering to the substrate during the smoothing process.

In this method of manufacturing an information recording medium, the applied layer may be semihardened in the first hardening process and a second hardening process that further hardens the applied layer may be carried out after the smoothing process has been carried out. Note that the expression to “semiharden” in this specification includes to harden the fluid material into various states where the fluidity of the fluid material has been lowered as a result of a hardening process compared to when the fluid material is applied but where the fluid material has not been completely hardened.

According to this method of manufacturing an information recording medium, during the smoothing process, it is possible to easily polish the applied layer that is not completely hardened and it is possible to smooth the surface of the substrate while efficiently removing (i.e., grinding away) the fluid material from the substrate without the removed (ground away) fluid material readhering to the substrate.

In this method of manufacturing an information recording medium, during the smoothing process, the surface of the applied layer may be polished to expose protruding end surfaces of convex parts in the concave/convex pattern formed on the substrate from the applied layer.

According to this method of manufacturing an information recording medium, it is possible to avoid having an unnecessary applied layer present between the protruding end surfaces of the convex parts used as divided recording elements and a magnetic head of a recording/reproducing apparatus (a hard disk drive or the like) in which the information recording medium is incorporated. As a result, it is possible to reduce the spacing loss between the magnetic head and the divided recording elements.

In this method of manufacturing an information recording medium, in the smoothing process, the surface of the substrate may be smoothed by rubbing the smoothing member onto the applied layer that is yet to be hardened and a third hardening process that hardens the applied layer may be carried out after the smoothing process has been carried out. Note that the expression “yet to be hardened” in this specification refers for example to a state where the applied fluid material is yet to be irradiated with radiation for the case where a radiation-curable resin is used as the fluid material and to a state where the applied fluid material is yet to be subjected to a heating process for the case where a thermosetting resin is used as the fluid material. That is, a state where the applied layer becomes only slightly hardened by room lighting or only slightly hardened by room temperature during a period from execution of the applied layer forming process to the start of the smoothing process is included as a “yet to be hardened” state.

According to this method of manufacturing an information recording medium, by smoothing the surface of the substrate by rubbing a smoothing member onto the applied layer that is yet to be hardened in the smoothing process, it is possible to smooth the surface of the substrate extremely easily compared to when the smoothing process is carried out on an applied layer that has been semihardened or completely hardened.

In this method of manufacturing an information recording medium, the applied layer may be formed in the applied layer forming process by applying the fluid material onto the substrate where at least protruding end surfaces of convex parts of the concave/convex pattern are covered by a protective layer. Here, a substrate where “at least protruding end surfaces of the convex parts in the concave/convex pattern are covered by the protective layer” for the present invention can be produced by carrying out a protective layer forming process that forms the protective layer so as to cover the concave/convex pattern of the substrate before the applied layer forming process is carried out. When the concave/convex pattern is formed on the substrate before the applied layer forming process, it is also possible to form the protective layer so as to cover the protruding end parts of the convex parts of the formed concave/convex patterns. More specifically, when the concave/convex pattern is formed on the substrate, for example, it is possible to form a protective layer on the surface of the substrate on which the concave/convex pattern is formed and then etch the protective layer and the substrate using a mask pattern formed on the protective layer to form a concave/convex pattern where the protruding end parts of the convex parts are covered by the protective layer.

According to this method of manufacturing an information recording medium, it is possible to avoid a situation where the protruding end parts of the convex parts used as divided recording elements are polished together with the applied layer during the smoothing process.

In addition, the applied layer forming process may be carried out by carrying out a resin layer forming process that forms a resin layer as the applied layer by applying a resin material as the fluid material onto the concave/convex pattern formation surface. Note that the expression “resin material” in the present specification includes various types of radiation-curable resin materials such as a UV-curable resin material or an electron beam-curable resin material, a thermosetting resin material, a thermoplastic resin material, and an SOG (Spin On Glass) material. The expression “resin material” in the present specification also includes various materials where an inorganic material component such as Al or Ti is substituted for the Si in an SOG material.

It should be noted that the disclosure of the present invention relates to the contents of Japanese Patent Application 2006-50577 that was filed on 27 Feb. 2006 and Japanese Patent Application 2007-14727 that was filed on 25 Jan. 2007, the entire contents of both of which are herein clearly incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic disk;

FIG. 2 is a cross-sectional view of a processed object on which concave/convex patterns have been formed;

FIG. 3 is a cross-sectional view of the processed object in a state where etching of a recording layer has been completed to form concave/convex patterns;

FIG. 4 is a cross-sectional view of the processed object in a state where the protective layer has been formed to cover the concave/convex patterns;

FIG. 5 is a cross-sectional view of the processed object in a state where a resin layer has been formed to cover the concave/convex patterns (i.e., the protective layer);

FIG. 6 is a cross-sectional view of the processed object and a burnishing apparatus while a smoothing process is being carried out on the resin layer;

FIG. 7 is a plan view of the processed object and the burnishing apparatus while the smoothing process is being carried out on the resin layer;

FIG. 8 is a cross-sectional view of the processed object in a state where the smoothing process has been completed;

FIG. 9 is a cross-sectional view of another magnetic disk;

FIG. 10 is a cross-sectional view of yet another magnetic disk;

FIG. 11 is a cross-sectional view of the processed object immediately after resin material has been applied (i.e., the resin layer has been formed) so as to cover the concave/convex patterns (i.e., the protective layer);

FIG. 12 is a cross-sectional view of the processed object in a state where the smoothing process on the resin layer has been completed;

FIG. 13 is a cross-sectional view of yet another magnetic disk;

FIG. 14 is a cross-sectional view of a processed object in a state where concave/convex patterns have been formed;

FIG. 15 is a cross-sectional view of a processed object in a state where the resin layer has been formed to cover concave/convex patterns;

FIG. 16 is a cross-sectional view of yet another magnetic disk;

FIG. 17 is a perspective view showing the appearance of another burnishing apparatus and a processed object;

FIG. 18 is a bottom view of a burnish head; and

FIG. 19 is a bottom view of another burnish head.

### DESCRIPTION OF THE PREFERRED EMBODIMENTS

Preferred embodiments of a method of manufacturing an information recording medium according to the present invention will now be described with reference to the attached drawings.

First, the construction of a magnetic disk 1 that is one example of an information recording medium according to the present invention will be described with reference to the drawings.

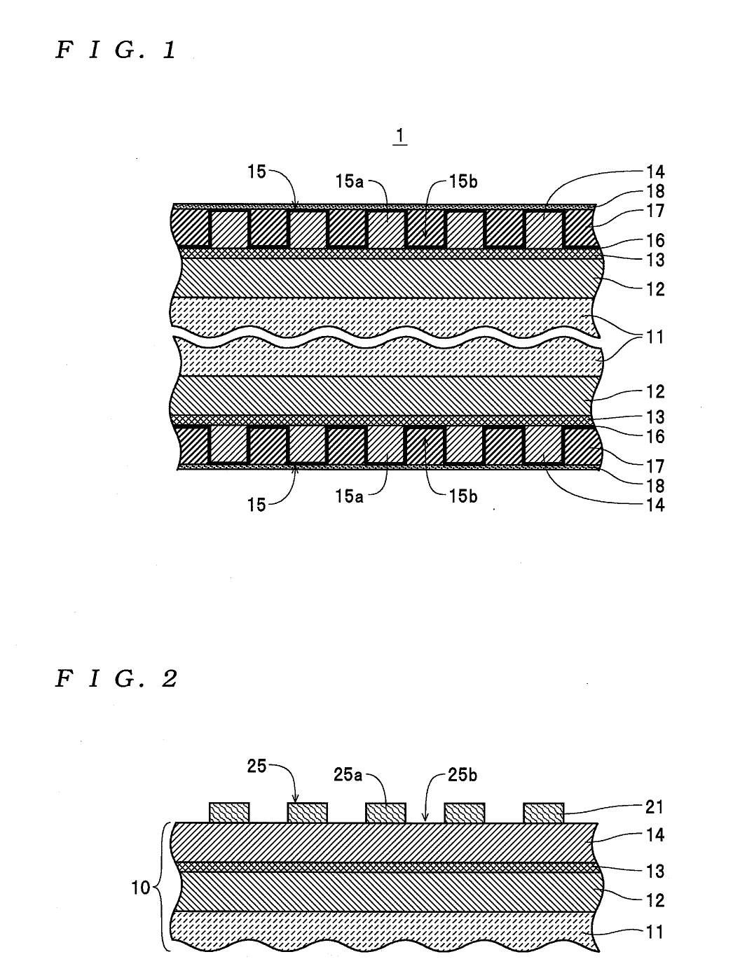

The magnetic disk 1 shown in FIG. 1 is a discrete track-type magnetic recording medium (a “patterned medium”) on which a plurality of concentric or spiral data recording tracks are formed and which is constructed so that data can be recorded by perpendicular recording. As described later, the magnetic disk 1 is manufactured according to the method of manufacturing an information recording medium according to the present invention using a processed object 10 shown in FIG. 2. In this case, the processed object 10 corresponds to a “substrate” for the present invention and is constructed by forming a soft magnetic layer 12, an intermediate layer 13, and a recording layer (magnetic recording layer) 14 in the mentioned order on both surfaces of a disk-shaped base plate 11. During the manufacturing of the magnetic disk 1, a metal mask layer 21 for forming a concave/convex pattern 25 to be used as a mask pattern and a resist layer (not shown) for forming concave parts 25b in the metal mask layer 21 by an etching process are formed on the front surface and rear surface of the processed object 10.

On the other hand, as shown in FIG. 1, the magnetic disk 1 is constructed with the soft magnetic layer 12, the intermediate layer 13, and the recording layer 14 formed in the mentioned order on both surfaces of the disk-shaped base plate 11. Concave/convex patterns 15 that function as data track patterns and servo patterns are formed on the magnetic disk 1 by forming a plurality of convex parts 15a (recording regions) as divided recording elements, at least protruding end parts of which are formed of magnetic material (i.e., the recording layer 14) and a plurality of concave parts 15b (non-recording regions). The expression “recording regions” in the present specification refers to regions constructed so as to retain a recorded magnetic signal in a readable manner (that is, regions constructed so as to have the ability to retain a magnetic signal in a readable manner). The expression “non-recording regions” in this specification refers to regions constructed so that the ability thereof to retain a magnetic signal in a readable manner is lower than that of the recording regions, or regions constructed so as to effectively not have such ability. More specifically, the “non-recording regions” in this specification are regions from which a smaller magnetic field is emitted than that emitted from the recording regions in a state where a magnetic signal has been recorded, or regions from which effectively no magnetic field is emitted.

Also, on the magnetic disk 1, the concave/convex patterns 15 described above are covered by a protective layer 16 and a resin layer 17 (one example of an “applied layer” for the present invention) is formed by filling the concave parts 15b in the concave/convex patterns 15 with a resin material (one example of a “fluid material” for the present invention) that is a non-magnetic material. Here, the magnetic disk 1 is smoothed so that the surfaces of the resin material (the resin layer 17) filled in the concave parts 15b become substantially flush with the surfaces of the protective layer 16 on the convex parts 15a. A lubricant 18 is also applied on the surface of the magnetic disk 1.

Next, the method of manufacturing the magnetic disk 1 will be described with reference to the drawings.

First, as shown in FIG. 2, concave/convex patterns 25 are formed on both recording layers 14 of the processed object 10. More specifically, as one example, the concave/convex patterns are formed by carrying out imprinting, for example, on the resist layers mentioned above that have been formed on the processed object 10. Note that for ease of understanding the present invention, the method of manufacturing the magnetic disk 1 will hereinafter be described with reference to only one surface of the processed object 10. A matrix (or “stamper”, not shown) used during the imprinting process has a plurality of concave parts that correspond to the convex parts 15a and a plurality of convex parts that correspond to the concave parts 15b of the magnetic disk 1 formed thereon. Accordingly, by pressing the matrix onto the resist layer to transfer the concave/convex patterns of the matrix to the resist layer, concave/convex patterns (not shown) with a plurality of convex parts corresponding to the convex parts 15a and a plurality of concave parts corresponding to the concave parts 15b of the concave/convex patterns 15 of the magnetic disk 1 are formed on the metal mask layer 21.

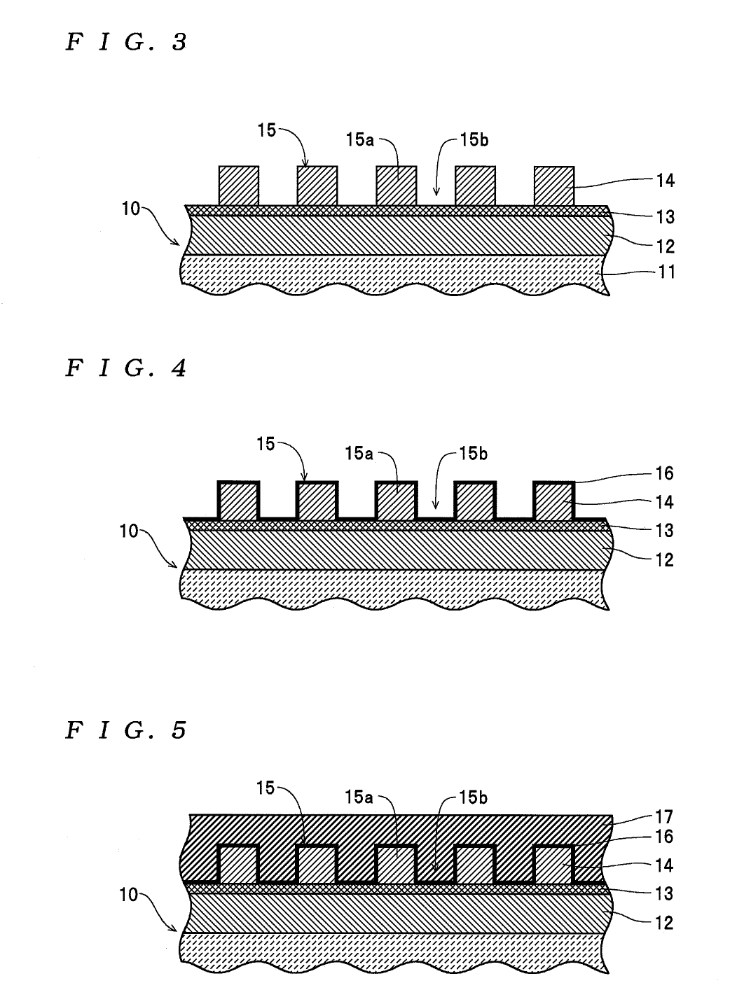

Next, by carrying out an etching process on the metal mask layer 21 with the concave/convex patterns described above as a mask pattern, as shown in FIG. 2, the concave/convex patterns 25 are formed on the recording layer 14. Note that although the resist layer (i.e., “residue”) will remain on the convex parts 25a in the concave/convex patterns 25 at a point when the etching process on the metal mask layer 21 is finished, for ease of understanding the present invention, such residue is omitted from the description and the drawings. Next, by etching the recording layer 14 using the concave/convex patterns 25 as a mask pattern and then removing the metal mask layer 21 by selective etching, as shown in FIG. 3, the concave/convex patterns 15 (one example of “concave/convex patterns” for the present invention) are formed in the recording layer 14. When doing so, a plurality of concave parts 15b with a depth that reaches the intermediate layer 13 are formed on the processed object 10 corresponding to the concave parts 25b of the concave/convex patterns 25. Note that in FIG. 3, for ease of understanding the present invention, the depth of the concave parts 15b is shown differently to the actual depth. Also, in the present embodiment, the upper surface of the processed object 10 in FIG. 3 (i.e., the surface on which the concave/convex patterns 15 are formed) corresponds to a “concave/convex pattern formation surface” for the present invention.

Next, a protective layer forming process that forms the protective layer 16 so as to cover at least protruding end parts of the convex parts 15a in the concave/convex patterns 15 formed on the processed object 10 (the substrate) is carried out before a resin layer forming process is carried out as an “applied layer forming process” for the present invention. When doing so, before the resin layer forming process described later, a process that forms the protective layer 16 to cover the formation surface of the concave/convex patterns 15 on the processed object 10 (i.e., so as to cover the concave/convex patterns 15) is executed as one example of the protective layer forming process described above. More specifically, as shown in FIG. 4, the protective layer 16 is formed by DLC (Diamond Like Carbon) so as to cover the surface of the concave/convex patterns 15 on the processed object 10 (one example of a state where “at least protruding end surfaces of the convex parts are covered by the protective layer” for the present invention). Note that as in the present embodiment, when the protective layer 16 is formed so as to cover the concave/convex patterns 15 before the resin layer 17 is formed, the upper surface of the protective layer 16 corresponds to the “concave/convex pattern formation surface” for the present invention. Next, as shown in FIG. 5, the resin layer 17 is formed on the concave/convex patterns 15 covered by the protective layer 16. As a specific example, a UV-curable resin material is applied by spin coating onto the formation surface of the concave/convex patterns 15 of the processed object 10.

When doing so, it is possible to use acrylic resin or epoxy resin as the resin material. Also, in place of a UV-curable resin material, it is possible to use various types of radiation-curable resin materials (as one example, an electron beam-curable resin material), a thermosetting resin material, a thermoplastic resin material, or the like. By doing so, the resin layer forming process as an “applied layer forming process” for the present invention is completed, and the resin layer 17 is formed on the processed object 10 with a thickness of around 5 nm to 20 nm from the protruding end surfaces of the convex parts 15a in the concave/convex patterns 15 (i.e., from the surfaces of the protective layer 16). Note that depending on the viscosity and/or the applied amount of the resin material, there are cases where the concave/convex forms of the concave/convex patterns 15 appear in the surface of the resin layer 17 so that the surface of the resin layer 17 also becomes undulating, but for ease of understanding the present invention, the surface of the resin layer 17 in FIG. 5 (the upper surface in the drawing) is shown as a flat surface.

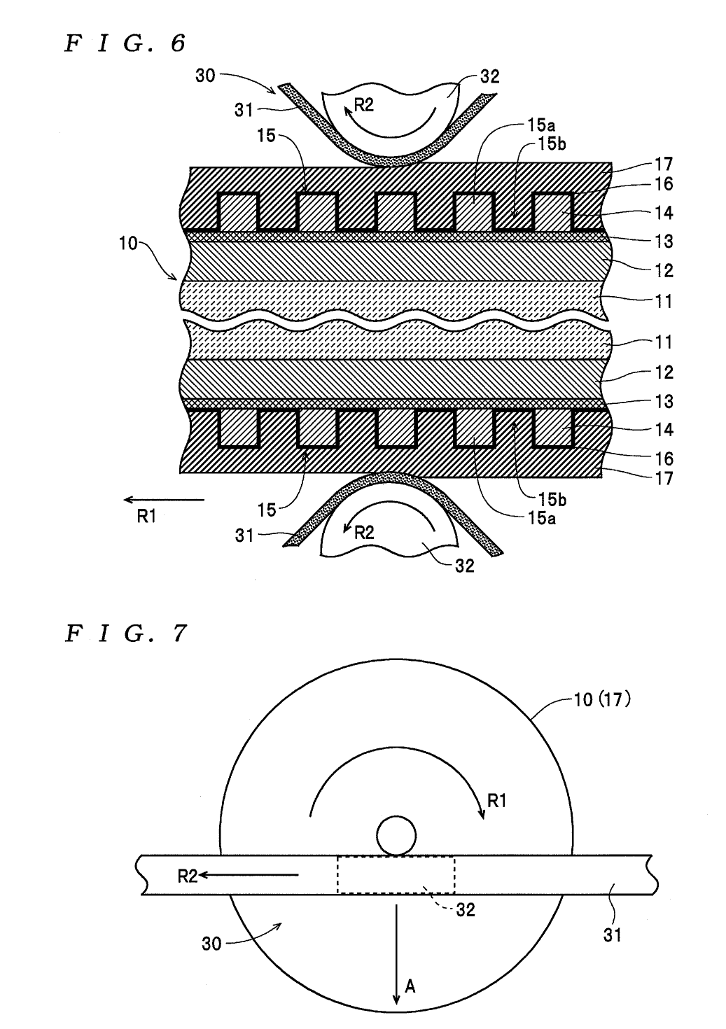

Next, the resin layer 17 on the processed object 10 is irradiated with UV rays to semiharden the resin layer 17 (i.e., a “first hardening process” for the present invention is carried out). When doing so, by appropriately adjusting the irradiation time for the UV rays and the power of the irradiated UV rays, it is possible to lower the fluidity of the resin material (the resin layer 17) immediately after the resin material has been applied by spin coating during the resin layer forming process described above so that the resin layer 17 is hardened to a hardness whereby the surface of the resin layer 17 can be sufficiently polished by a burnishing apparatus 30 (see FIGS. 6 and 7) during a smoothing process described later. Note that when a thermosetting resin material is used when forming the resin layer 17, by appropriately adjusting the execution time and/or the temperature of a heating process carried out on the resin layer 17, it is possible to reduce the fluidity of the resin material (i.e., the resin layer 17) to a desired state. Also, when a thermoplastic resin material is used when forming the resin layer 17, it is possible to harden the resin layer 17 by cooling the thermoplastic resin material that has been heated to the glass transition point or above during the application process to a temperature that is at or below the glass transition point (for example by leaving the resin layer 17 for a predetermined time so that the resin layer 17 cools to room temperature).

Next, as shown in FIGS. 6 and 7, the surface of the semihardened resin layer 17 is polished by the burnishing apparatus 30 to smooth the surface of the processed object 10 on which the concave/convex pattern 15 has been formed (in this example, the concave/convex patterns 15 are formed on both surfaces of the processed object 10), or in other words, the “smoothing process” for the present invention is carried out. Here, the burnishing apparatus 30 includes burnishing tapes 31 for polishing the surfaces of the polished object (i.e., the resin layers 17 on the processed object 10), a pair of rollers 32 for rubbing the burnishing tapes 31 onto the polished object, and a rotating mechanism (not shown) for rotating the polished object (the processed object 10) in the direction of the arrow R1. Note that FIG. 6 is a cross-sectional view of the processed object 10 and the resin layers 17 along the circumferential direction during execution of the polishing process on the resin layers 17.

Each burnishing tape 31 corresponds to a “dry polishing member” for the present invention and as one example is formed by sticking an abrasive material to one surface of a backing tape that is around 10 mm wide. The rollers 32 respectively press the abrasive material surfaces of the burnishing tapes 31 onto the surfaces of both resin layers 17 with a constant load. The rollers 32 are constantly rotated in the direction of the arrow R2 shown in FIG. 6 at an extremely low speed during execution of the polishing process on the resin layers 17 to feed the burnishing tapes 31. Also, as shown in FIG. 7, the rollers 32 are gradually moved by a moving mechanism, not shown, from a position where the burnishing tapes 31 are pressed onto a center of the processed object 10 in the direction of the arrow A toward the outer edge of the processed object 10. By doing so, the burnishing tapes 31 are pressed onto the entire area from the center to the outer edge of the processed object 10.

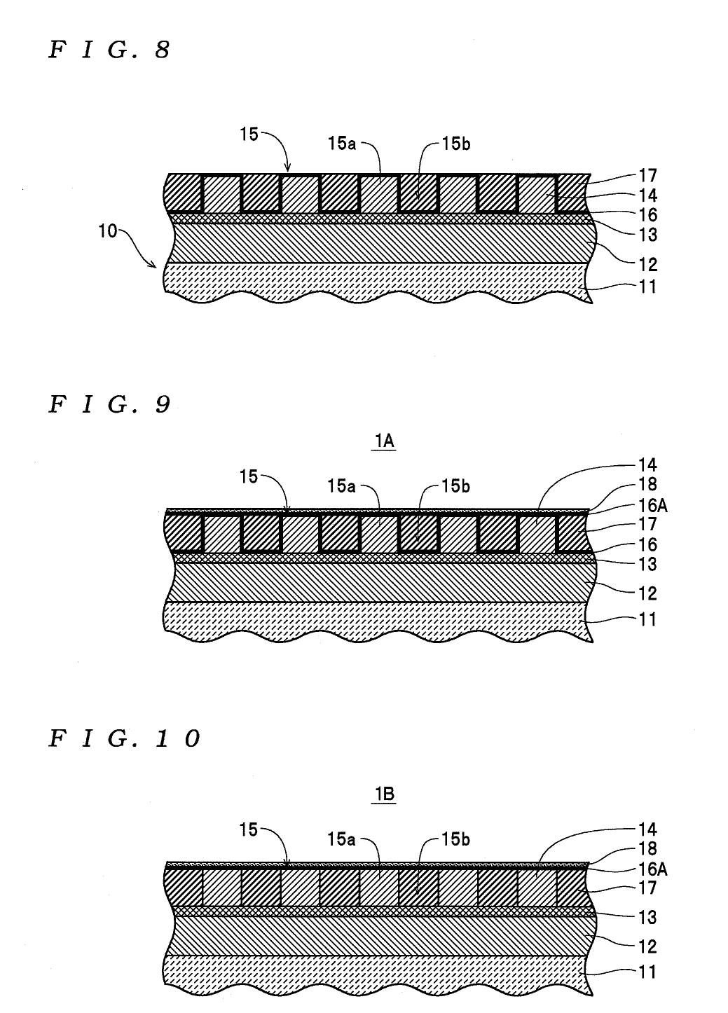

During the polishing process carried out by the burnishing apparatus 30, a state is maintained where the rollers 32 that press the burnishing tapes 31 onto the resin layers 17 are continuously rotated at an extremely low speed while the processed object 10 (the resin layers 17) is/are being rotated in the direction of the arrow R1 by a rotating mechanism. As a result, the abrasive material surfaces of the burnishing tapes 31 are rubbed against the surfaces of the resin layers 17 and as shown in FIG. 6, the surfaces of the resin layers 17 are ground and simultaneously caused to plastically deform. When doing so, by continuously rotating the respective rollers 32 at low speed in the direction of the arrows R2, clogging of the burnishing tapes 31 by ground fragments of the resin layer 17 is avoided. Also, each position on the surfaces of the resin layers 17 may be polished a plurality of times as necessary. By doing so, as shown in FIG. 8, both surfaces of the processed object 10 (i.e., the formation surfaces of the concave/convex patterns 15) are smoothed with the protective layers 16 on the convex parts 15a and the protruding end surfaces of the convex parts 15a becoming exposed from the resin layers 17. When doing so, since the protruding end surfaces of the convex parts 15a are covered by the protective layers 16, a situation where the polishing with the burnishing tapes 31 continues as far as the convex parts 15a is avoided. By doing so, the polishing process carried out as the smoothing process for the present invention is completed.

Next, by irradiating the processed object 10 for which the smoothing process has been completed (i.e., the resin layers 17 that fill the concave parts 15b) with UV rays, the resin layers 17 are completely hardened (i.e., a “second hardening process” for the present invention is carried out). When doing so, by appropriately adjusting the irradiation time for the UV rays and the power of the irradiated UV rays, it is possible to sufficiently harden both resin layers 17. Note that when a thermosetting resin material is used when forming the resin layers 17, by appropriately adjusting the execution time and/or the temperature of a heating process carried out on both resin layers 17, it is possible to sufficiently harden the resin material (i.e., both resin layers 17). After this, the lubricant 18 is applied onto both surfaces of the processed object 10. By doing so, as shown in FIG. 1, the magnetic disk 1 is completed.

In this way, according to the method of manufacturing the magnetic disk 1, by manufacturing the magnetic disk 1 by carrying out the resin layer forming process (i.e., the “applied layer forming process”), which forms the resin layers 17 (i.e., the “applied layers”) by applying resin material (i.e., the “fluid material”) onto the surfaces of the processed object 10 on which the concave/convex patterns 15 are formed, and the smoothing process, which smoothes the surfaces of the processed object 10 by rubbing burnishing tapes 31 (“smoothing members”) against the resin layers 17, unlike a method of manufacturing where the surfaces of a preform (substrate) are smoothed by polishing the surface of a non-magnetic layer using CMP, it is possible to proceed to the following manufacturing process without having to carry out a removing process (washing process) to remove polishing slurry after the smoothing has been completed. Accordingly, it is possible to sufficiently improve the throughput when manufacturing the magnetic disk 1. Here, unlike a method of manufacturing that fills concave parts with a non-magnetic material such as silicon oxide, with the method of manufacturing that forms resin layers 17 by applying the fluid material (in this example, the resin material), it is possible to reliably and sufficiently smooth the surface of the processed object 10 using an apparatus with a comparatively simple construction, such as the burnishing apparatus 30.

Also, according to the method of manufacturing the magnetic disk 1, the first hardening process that hardens the resin layers 17 to reduce the fluidity of the resin material compared to when the resin material is applied is carried out before the smoothing process described above, and during the smoothing process the surfaces of the processed object 10 are smoothed by polishing using the burnishing tapes 31 (i.e., dry polishing members) as smoothing members for the present invention. This means that during the smoothing process, the surfaces of the processed object 10 can be smoothed while efficiently removing (i.e., grinding away) the resin material from the processed object 10 without the resin material removed (ground away) by the burnishing tapes 31 readhering to the processed object 10.

In addition, according to the method of manufacturing the magnetic disk 1, by semihardening the resin layers 17 during the first hardening process and carrying out a second hardening process that further hardens the resin layers 17 after the smoothing process has been carried out, during the smoothing process, the resin layers 17 that have not been completely hardened can be easily polished and it is possible to smooth the surfaces of the processed object 10 while efficiently removing (i.e., grinding away) the resin material from the processed object 10 without the resin material removed (ground away) readhering to the processed object 10.

According to the method of manufacturing the magnetic disk 1, by polishing the surfaces of the resin layers 17 during the smoothing process to expose the protruding end surfaces of the convex parts 15a of the concave/convex patterns 15 formed on the processed object 10 from the resin layers 17, it is possible to avoid having unnecessary resin layers 17 present between the protruding end surfaces of the convex parts 15a used as divided recording elements and a magnetic head of a recording/reproducing apparatus (a hard disk drive or the like) in which the magnetic disk 1 is incorporated. As a result, it is possible to reduce the spacing loss between the magnetic head and the discrete recording elements.

In addition, according to the method of manufacturing the magnetic disk 1, by forming the resin layers 17 by applying resin material onto the processed object 10 (substrate) in a state where at least the protruding end surfaces of the convex parts 15a of the concave/convex patterns 15 (in this example, the entire concave/convex patterns 15) are covered by the protective layers 16, during the smoothing process, it is possible to avoid a situation where the protruding end parts of the convex parts 15a used as the divided recording elements are polished together with the resin layers 17.

Note that the present invention is not limited to the construction and method described above. For example, during the manufacturing of the magnetic disk 1 described above, although the protective layers 16 are formed so as to cover the concave/convex patterns 15 before the smoothing process for the present invention, it is also possible to use a method of manufacturing where, like a magnetic disk 1A shown in FIG. 9, protective layers 16A are also formed on the convex parts 15a (i.e., on the protective layers 16 of the convex parts 15a) and on the resin layers 17 inside the concave parts 15b after the polishing process carried out on the resin layers 17 (i.e., the smoothing process for the present invention) has been completed. By doing so, the resin layers 17 inside the concave parts 15b are protected by the protective layers 16A, and as a result it is possible to avoid a situation where the non-recording regions become greatly damaged during contact with a magnetic head or the like. Note that in FIG. 9 and in FIGS. 10 to 16 described later, component elements that are the same as the elements of the magnetic disk 1 described above have been assigned the same reference numerals and duplicated description thereof is omitted. It is also possible to use a method of manufacturing where, like the magnetic disk 1B shown in FIG. 10, protective layers 16A are formed on the convex parts 15a and on the resin layers 17 inside the concave parts 15b after the smoothing process for the present invention has been completed, without the protective layers 16 described above being formed (before the process that forms the resin layers 17).

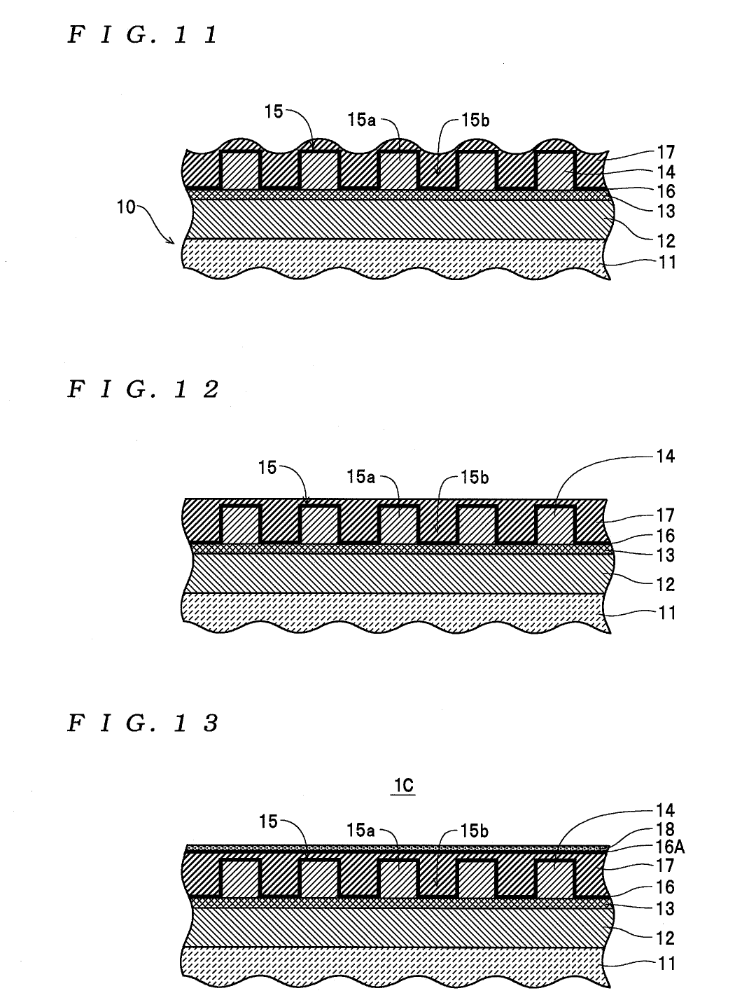

Also, although a hardening process that semihardens the resin layers 17 (i.e., the “first hardening process” for the present invention) is carried out before the start of the smoothing process (i.e., the polishing process carried out on the resin layers 17) when manufacturing the magnetic disk 1 described above, it is also possible to use a method where the resin layer 17 is completely or substantially completely hardened before the start of the smoothing process for the present invention. In addition, it is possible to use a method that manufactures a magnetic disk without hardening the resin layer 17 before the smoothing process. More specifically, as shown in FIG. 11, the resin layers 17 are formed by applying a UV-curable resin material, for example, on the concave/convex patterns 15. When doing so, as shown in FIG. 11, depending on the viscosity and/or the applied amount of the resin material, there are cases where the concave/convex forms of the concave/convex patterns 15 appear in the surfaces of the resin layers 17 so that the surfaces of the resin layers 17 also become undulating. Note that for ease of understanding the present invention, the undulating form of the surface of the resin layer 17 has been exaggerated in FIG. 11.

Next, the smoothing process starts without the hardening process being carried out on the resin layer 17. More specifically, as one example, the surfaces of the resin layers 17 that have not been hardened are smoothed by polishing with the burnishing apparatus 30 while rotating the processed object 10 using a rotating mechanism (not shown). When doing so, parts of the resin layers 17 (i.e., some of the resin material as the “fluid material”) on the convex parts 15a move onto the concave parts 15b (i.e., the resin layers 17 plastically deform), and other parts of the resin layers 17 (i.e., the rest of the resin material) on the convex parts 15a (i.e., excess resin material) are removed from the processed object 10 by the burnishing tapes 31, thereby exposing the protruding end surfaces of the convex parts 15a (i.e., the protective layer 16) from the resin layer 17. By doing so, as shown in FIG. 8, the surfaces of the resin layers 17 are smoothed. Next, by applying the lubricant 18 onto both surfaces of the processed object 10 after the resin layers 17 for which the smoothing process has been carried out have been hardened by irradiation with the UV rays (a “third hardening process” for the present invention), the magnetic disk 1 is completed as shown in FIG. 1.

In this way, according to the method of manufacturing the magnetic disk 1, by smoothing the surfaces of the processed object 10 by rubbing the burnishing tapes 31 (i.e., dry polishing members) as smoothing members onto the resin layers 17 that have not been hardened when the smoothing process is carried out, it is possible not only to sufficiently improve the throughput when manufacturing the magnetic disk 1 in the same way as the method of manufacturing described earlier, but also to smooth the surfaces of the processed object 10 extremely easily compared to when the smoothing process is carried out on resin layers 17 that have been semihardened or completely hardened.

On the other hand, it is also possible during the smoothing process in the method of manufacturing described above to smooth the surfaces of the processed object 10 by smoothing the resin layers 17 (the resin material) using a plate-shaped member (a scraper or the like, not shown) as the smoothing member according to the present invention in place of the burnishing apparatus 30 (one example of a method where the surfaces of the processed object 10 are smoothed by causing plastic deformation of the surfaces of the resin layer 17 without grinding). More specifically, by rubbing a plate-shaped member against the surface of each resin layer 17 that is yet to be hardened while rotating the processed object 10 at low speed using a rotating mechanism, it is possible to cause the resin layer 17 on the convex parts 15a to move onto the concave parts 15b (the resin layer 17 is plastically deformed). By doing so, as shown in FIG. 12, the surfaces of the resin layers 17 are smoothed. After this, by hardening the resin layers 17 (the “third hardening process” for the present invention), forming the protective layers 16A, and applying the lubricant 18, the magnetic disk 1C is completed as shown in FIG. 13. According to this method of manufacturing the magnetic disk 1C, by smoothing the surfaces of the processed object 10 by rubbing the plate-shaped members as smoothing members against the resin layers 17 that have not been hardened when the smoothing process is carried out, compared to when the smoothing process is carried out on semihardened or completely hardened resin layers 17, it is possible to smooth the surfaces of the processed object 10 extremely easily.

Also, although a method of forming the resin layers 17 by applying the resin material onto the processed object 10 in a state where the convex parts 15a and the concave parts 15b of the concave/convex patterns 15 are covered by the protective layers 16 as one example of a substrate where “at least the protruding end surfaces of the convex parts are covered by a protective layer” has been described, the present invention is not limited to this. For example, when concave/convex patterns are formed on a substrate (the processed object 10) before the resin layer forming process as the “applied layer forming process” for the present invention, it is possible to use a method that forms protective layers so that the protruding end parts of the convex parts in the formed concave/convex patterns are covered. To use this method, as one example, when forming the concave/convex patterns on the substrate for the present invention, it is possible to form a protective layer on each surface of the substrate on which the concave/convex patterns are to be formed and then etch the protective layer and the substrate using a mask pattern formed on the protective layer to form concave/convex patterns where the protruding end parts of the convex parts are covered by the protective layer.

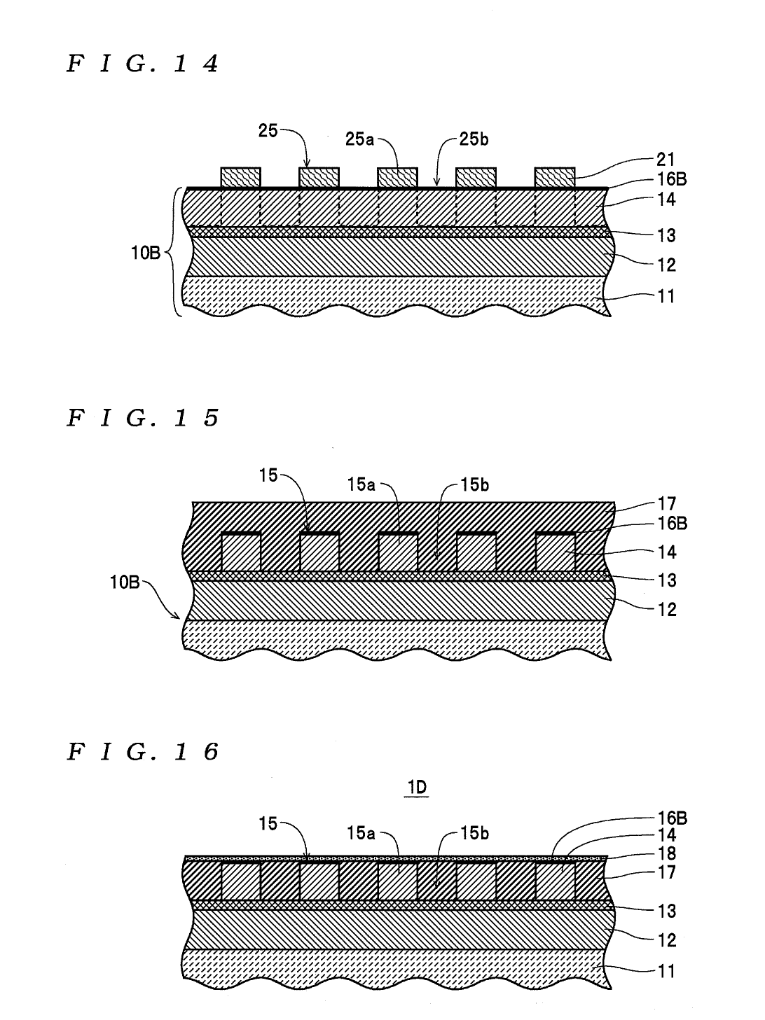

More specifically, as shown in FIG. 14, for example, the concave/convex patterns 25 are first formed on the processed object 10B where the protective layers 16B have been formed to cover the recording layers 14 and an etching process is carried out on the protective layers 16B using the concave/convex patterns 25 (the metal mask layers 21) as mask patterns. After this, an etching process is carried out on the recording layers 14 using one or both of the concave/convex patterns 25 (the metal mask layers 21) and the protective layers 16B for which the patterning by the etching process described above has been completed as a mask pattern. Next, if the metal mask layers 21 remain on the protective layers 16B, the metal mask layers 21 are removed by selective etching. By doing so, the concave/convex patterns 15 (another example of the “concave/convex patterns” for the present invention) are formed in the recording layers 14 (not shown). In this method of manufacturing, only the protruding end surfaces of the convex parts 15a of the concave/convex patterns 15 are covered by the protective layers 16B (see FIG. 15). By doing so, the substrate for the present invention is completed.

Next, as shown in FIG. 15, the resin layers 17 are formed on the concave/convex patterns 15 where the protruding end surfaces of the convex parts 15a are covered by the protective layers 16. More specifically, as one example, a UV-curable resin material is applied by spin coating onto the surfaces of the processed object 10 on which the concave/convex patterns 15 have been formed. Next, after the resin layers 17 have been semihardened by irradiating the resin layers 17 on the processed object 10B with UV rays (i.e., after the first hardening process for the present invention has been carried out), the surfaces of the resin layers 17 are polished using the burnishing apparatus 30 to smooth the surfaces of the processed object 10 (i.e., a polishing process is carried out as the smoothing process for the present invention). When doing so, since the protruding end surfaces of the convex parts 15a are covered by the protective layers 16, a situation where the polishing with the burnishing tapes 31 continues as far as the convex parts 15a is avoided. Next, by irradiating the processed object 10B for which the smoothing process has been completed (i.e., the resin layers 17 that fill the concave parts 15b) with UV rays, the resin layers 17 are completely hardened (i.e., the “second hardening process” for the present invention is carried out). After this, the lubricant 18 is applied onto both surfaces of the processed object 10. By doing so, as shown in FIG. 16, the magnetic disk 1D is completed.

In this way, even with a method that forms the resin layers 17 on the processed object 10B in a state where only the protruding end surfaces of the convex parts 15a are covered by the protective layers 16B without the protective layers 16 being formed so as to cover the entire concave/convex patterns 15, during the smoothing process carried out on the resin layers 17, it is possible to sufficiently avoid a situation where not only the resin layers 17 (the resin material) but also the recording layers 14 (i.e., the convex parts 15a) are polished. Note that the method of manufacturing the processed object 10B where only the protruding end surfaces of the convex parts 15a are covered by the protective layers 16B is not limited to the example described above.

Also, although an example has been described where the resin layer 17 is formed as an “applied layer” for the present invention using various types of resin material as the “fluid material” for the present invention, the method of manufacturing an information recording medium according to the present invention is not limited to this. For example, during the applied layer forming process for the present invention, by forming the applied layer by applying an SOG material in place of the resin material described above and then hardening the applied layer by carrying out a heating process, it is possible to use a method that forms a layer of SiO₂ as the “applied layer” for the present invention (i.e., a method that changes an applied layer of an SOG material to an SiO₂ layer by carrying out a heating process). Also, by forming the applied layer by applying a fluid material including various types of inorganic materials such as Al, Ti, and the like in place of the Si in the SOG material and then hardening the applied layer by carrying out a heating process, it is possible to use a method that forms various types of inorganic material layer as the “applied layer” for the present invention (i.e., a method of changing the applied layer of the fluid material described above to various types of inorganic material layer by carrying out a heating process). In addition, in place of the resin material, it is possible to use a method that forms a lubricant layer as the “applied layer” by applying various types of fluoride lubricant, such as perfluoropolyether, onto the concave/convex pattern formation surface by carrying out dipping, for example. When the lubricant has been applied by dipping, the fluidity of the lubricant gradually falls due to the solvent included in the lubricant starting to vaporize when the substrate is pulled out of the vessel containing the lubricant (i.e., when the substrate is pulled out of the lubricant in the vessel), or in other words, as soon as the applied lubricant comes into contact with the atmosphere). Accordingly, when lubricant has been applied by dipping during the applied layer forming process for the present invention, the first hardening process for the present invention starts when the substrate is pulled out of the vessel.

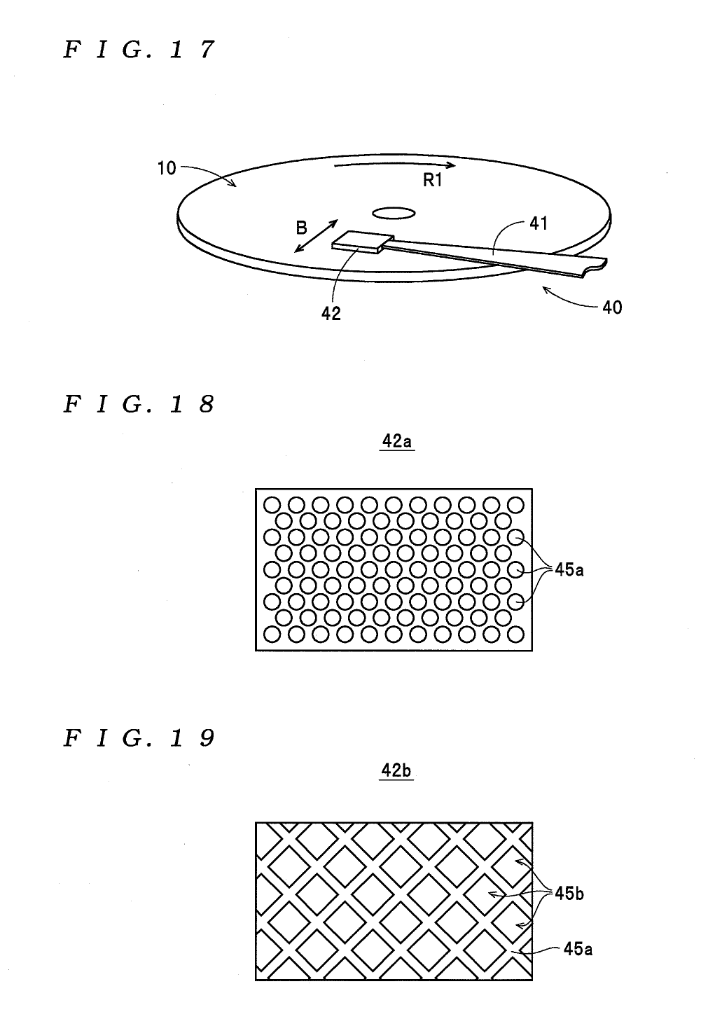

Also, although an example has been described where during manufacturing of the magnetic disk 1, the surfaces of the processed object 10 are smoothed using the burnishing apparatus 30 constructed so that the resin layers 17 are rubbed by the burnishing tapes 31 using the rollers 32, it is also possible to use a method where the resin layers 17 are polished using a burnishing apparatus 40 shown in FIG. 17 in place of the burnishing apparatus 30. The burnishing apparatus 40 includes a rotating mechanism (not shown) for rotating the processed object 10 on which a resin layer 17 has been formed in the direction of the arrow R1 and a swing arm 41 for moving a burnish head 42 attached to the front tip of the swing arm 41 in the direction of the arrow B over the processed object 10 (i.e., over the resin layer 17). Note that a plurality of convex parts to which an abrasive material adheres or a plurality of convex parts constructed of an abrasive material are formed on the bottom surface of the burnish head 42 and the burnish head 42 is constructed so as to be capable of polishing the resin layer 17 by rubbing the resin layer 17 with the protruding end surfaces of the convex parts. More specifically, it is possible to use a burnish head 42a like that shown in FIG. 18 including a plurality of convex parts 45a with circular protruding end surfaces or a burnish head 42b like that shown in FIG. 19 including a plurality of concave parts 45b that are segmented by a lattice-shaped convex part 45a.

In addition, the dry polishing members for the present invention are not limited to the burnishing tapes 31 and the burnish head 42 and it is possible to carry out a polishing process as the smoothing process for the present invention using various types of dry polishing members such as abrasive paper, abrasive cloth, and grindstones. Also, although a method that smoothes the surfaces of the processed object 10 by grinding the surfaces of the resin layers 17 while causing plastic deformation during the polishing process has been described, a polishing process that can be carried out as the smoothing process for the present invention is not limited to this. It is also possible to use a method that completely or substantially completely hardens the resin layers 17 before the polishing process and smoothes the surfaces of the processed object 10 without causing plastic deformation by grinding away the surfaces of the resin layers 17 by carrying out a grinding process as the polishing process (the smoothing process).

In addition, although on the magnetic disk 1 described above, the convex parts 15a in the concave/convex patterns 15 are entirely formed of the recording layer 14 (i.e., magnetic material) from the protruding end parts thereof (i.e., the magnetic disk 1 surface-sides of the convex parts 15a) to the bottom end parts thereof, the construction of the information recording medium manufactured using the method of manufacturing according to the present invention is not limited to this. More specifically, when etching a recording layer 14 using the concave/convex patterns 25 (the mask patterns), by reducing the amount of etching by a certain amount (i.e., by making the formed concave parts 15b shallower), it is possible to construct a magnetic disk (not shown) by forming not only the convex parts 15a (i.e., the recording regions) but also bottom parts of the concave parts 15b (i.e., the non-recording regions) of the recording layer 14.

Alternatively, when etching a recording layer 14 using the concave/convex patterns 25, by increasing the amount of etching by a certain amount (i.e., by making the concave parts 15b deeper), it is possible to construct a magnetic disk (not shown) where the concave/convex patterns 15 are formed with a plurality of convex parts 15a (recording regions) where only the protruding end parts of the convex parts 15a (i.e., the magnetic recording medium surface-sides of the convex parts 15a) are formed of the recording layer 14 and the bottom end parts are formed of non-magnetic material, a soft magnetic material, or the like. As another example, by forming the concave/convex patterns 25 described above on the disk-shaped base plate 11 and etching the disk-shaped base plate 11 using the concave/convex patterns 25 as mask patterns to form concave/convex patterns (concave/convex patterns where the positional relationship between the concaves and convexes is the same as in the concave/convex patterns 15: not shown) on the disk-shaped base plate 11 and then forming a thin recording layer 14 so as to cover such concave/convex patterns, it is possible to construct a magnetic disk on which are formed concave/convex patterns 15 with a plurality of convex parts 15a (recording regions) whose surfaces are covered with magnetic material and a plurality of concave parts 15b (non-recording regions) whose bottom surfaces are also formed with the magnetic material.

The information recording medium manufactured using the method of manufacturing according to the present invention is not limited to a magnetic recording medium for perpendicular recording like the magnetic disk 1, and can also be applied to a magnetic recording medium for longitudinal recording. In addition, although a plurality of concentric or spiral data recording tracks are formed on the magnetic disk 1 described above, the construction of the information recording medium manufactured using the method of manufacturing according to the present invention is not limited to this and also includes a patterned medium where recording regions that construct the data recording tracks are also separated from one another in the circumferential direction of the magnetic recording medium by non-recording regions. The information recording medium manufactured using the method of manufacturing according to the present invention is also not limited to an information recording medium for double-sided recording like the magnetic disk 1 described above and also includes an information recording medium for single-sided recording. In addition, the information recording medium manufactured using the method of manufacturing according to the present invention is also not limited to a magnetic recording medium such as a magnetic disk and also includes various types of information recording media such as an optical disk or a magneto-optical disk.

What is claimed is:

1. A method of manufacturing an information recording medium, comprising:
an applied layer forming process that applies a fluid material onto a concave/convex pattern formation surface of a substrate where a concave/convex pattern is formed to form an applied layer; and
a smoothing process that smoothes the surface of the substrate by rubbing a smoothing member against the applied layer.

2. A method of manufacturing an information recording medium according to claim 1,
wherein a first hardening process, which hardens the applied layer so as to lower the fluidity of the fluid material compared to when the fluid material is applied, is carried out before the smoothing process, and
in the smoothing process, the surface of the applied layer is polished using a dry polishing member as the smoothing member to smooth the surface of the substrate.

3. A method of manufacturing an information recording medium according to claim 2,
wherein the applied layer is semihardened in the first hardening process and a second hardening process that further hardens the applied layer is carried out after the smoothing process has been carried out.

4. A method of manufacturing an information recording medium according to claim 2,
wherein during the smoothing process, the surface of the applied layer is polished to expose protruding end surfaces of convex parts in the concave/convex pattern formed on the substrate from the applied layer.

5. A method of manufacturing an information recording medium according to claim 1,
wherein in the smoothing process, the surface of the substrate is smoothed by rubbing the smoothing member onto the applied layer that is yet to be hardened and a third hardening process that hardens the applied layer is carried out after the smoothing process has been carried out.

6. A method of manufacturing an information recording medium according to claim 1, wherein in the applied layer forming process, the applied layer is formed by applying the fluid material onto the substrate where at least protruding end surfaces of convex parts of the concave/convex pattern are covered by a protective layer.

7. A method of manufacturing an information recording medium according to claim 1, wherein the applied layer forming process is carried out by carrying out a resin layer forming process that forms a resin layer as the applied layer by applying a resin material as the fluid material onto the concave/convex pattern formation surface.
